(19) United States
(12) Patent Application Publication
(10) Pub. No.: US 2004/0236612 A1
(43) Pub. Date: Nov. 25, 2004

(54) Method for hybrid life insurance plan

(76) Inventors: Robert T. Heusinkveld, Plano, TX (US); John H. Heusinkveld, Carrollton, TX (US)

Correspondence Address: HOWISON & ARNOTT, L.L.P, P.O. BOX 741715, DALLAS, TX, 75374-1715, US

(21) Appl. No.: 10/443,605

(22) Filed: May 22, 2003

(51) Int. Cl. G06F 17/60

(52) U.S. Cl. 705/4

(57) ABSTRACT

A method for providing life insurance includes issuing a life insurance policy to an insured with a face amount payable to a beneficiary and a term certain. Premiums are collected periodically from the insured until either the term certain expires or the death of the insured, whichever comes first. The life insurance policy includes a decreasing term component and a paid-up component, such that the face amount of the life insurance policy is paid to the beneficiary upon the death of the insured. The life insurance policy has no cash surrender value.

### TECHNICAL FIELD OF THE INVENTION

This invention is related in general to methods of providing insurance and, in particular, for a life insurance plan.

### BACKGROUND OF THE INVENTION

Life insurance has long been a staple of financial planning. As the needs and dimensions of the market for life insurance have changed tirough the years, a wide variety of plans for providing life insurance have been developed. The complexity of most of these plans can be intimidating and create barriers of understanding between insurance providers and their customers. A life insurance plan that is easy for the customer to understand has many advantages in the marketplace. This may be particularly true in the employee benefit plan miarket, where the sophistication of the insured with regard to insurance plans may be low.

A majority of corporations provide access to life insurance benefits for their employees. That benefit is typically provided through group term life insurance. In traditional group term plans, the employee designates the beneficiary of the contract. Depending on the plan design, the cost of this benefit may be subsidized by the employer.

A wide variety of life insurance plans can be purchased. Some insure against death or disability for a limited number of years only, while others cover an entire life; some call for the payment of premiums for a stated number of years only, others for the entire duration of the contract; for some, premiums are fixed, whereas with others the policy owner determines the level of premiums to be paid, within certain guidelines. Some insurance establishes a cash value, whereas others only provide a death benefit payment. Some insurance promises a payment ofpolicy benefits in one lump sum, whereas others provide for payment in a fixed number of installments.

Historically, life insurance benefit patterns have fit into one or a combination of three classes: “term life insurance”, “endowment insurance” and “whole life insurance”. Term life insurance pays a predetermined sum to a beneficiary if the insured's death occurs during a set number of years (the term of the insurance contract) that is less than an typical lifetime. Endowment insurance, like term insurance, pays a predetermined sum to a beneficiary if the insured's death occurs during the contract term and addifionally, typically, pays the same predetermined sum to the policy holder ifthe insured survives the contract term. Whole life insurance pays a predetermined sum to a beneficiary when the insured dies, regardless of when death occurs. Term contracts or policies typically have no cash values whereas the opposite is true of endowment and whole life policies.

There are many different variations of term life insurance policies and even more of whole life insurance policies. For example, there is “ordinary life” which provides whole life insurance with premiums that are payable during an entire lifetime. Other names for ordinary life include “straight life” and “continuous-premium whole life”. There is also “limited-payment whole life” policies where the face amount of the policy is payable at death, but premiums are charged for a limited number of years, after which the policy becomes paid-up for its full face amount.

There is also “indeterminate-premium whole life insurance”. The key to this contract is a premium that is lower than the maximum permissible contractual obligation. In effect, a significant discount from the maximum premium is guaranteed for the first few contract years. Annually thereafter, the premium actually payable is set by the company, subject to a maximum constraint. The policy is designed to reflect, through its premium structure, up-to-date expectations as to future operating experience.

Another kind of insurance is “current assumption whole life” where policies provide life insurance under a non-traditional, transparent format that relies on an indeteminate-premium structure. These policies typically use new-money interest rates and current mortality tables in their cash-value determination. This fact has led to the products being referred to as “interest-sensitive whole life.”

Yet another kind of policy is “variable life insurance” which is whole life insurance whose values will vary directly with the performance of a set of earmarked investments. Other policies include “modified life,” “enhanced ordinary life,” “graded premium whole life,” “single-premium whole life” and “indexed whole life.” Details concerning all of these policies and other insurance concepts and information may be acquired by reference to: Black & Skipper, Life Insurance, (Prentice Hall, 12^{th} Edition 1994). Helpful definitions may be found in: Ingriano & Ingrisano, The Insurance Dictionary, (Dearbom Financial Publishing, 3rd Edition 1990). Relevant portions of both books are incorporated herein by reference.

As the economy and consumer attitudes undergo constant change, the investment value of a life insurance policy may become a secondary considerafion for the insured. The death benefit of life insurance, rather than an accumulatng cash surrender value, may be the principal reason that insurance is purchased. This aspect may have particular relevance in the employee benefit market, where the death benefit is one of the primary concerns of the employer and employees.

A disadvantage ofterm life insurance is that the policy does not pay any benefits to the insured once the term is reached and so the benefits of term life insurance are not reasonably available beyond a certain age.

What is therefore needed is a fixed premium life insurance plan that provides a fixed death benefit over the entirety of the insred's life.

### SUMMARY OF THE INVENTION

A method for providing life insurance includes issuing a life insurance policy to an insured with a face amount payable to a beneficiary and a term. Premiums are collected periodically from the insured until the earlier of the expiration of the term or the death of the insured. The life insurance policy includes a decreasing term component and a paid-up component, such that the face amount of the life insurance policy is paid to the beneficiary upon the death of the insured. The life insurance policy has no cash surrender value.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a system diagram of the insurance process;

FIG. 2 illustrates a flowchart of the issue process;

FIG. 3 illustrates a flowchart of the insurance process;

FIG. 4 illustrates a flowchart of the insurance process in accordance with another embodiment;

FIG. 5 illustrates a graph of the policy values;

FIG. 5a illustrates detail of the graph of policy values;

FIG. 6 illustrates comparative chart of annual premiums;

FIG. 7 illustrates a comparative chart of monthly premiums;

FIG. 8 illustrates a comparative chart of paid-up insurance amounts; and

FIG. 9 illustrates a comparative chart with Universal Life Insurance.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

Withreference to FIG. 1, a depiction ofsome of the transactions involved in an insurance plan in accordance with one aspect of the invention is shown An applicant 100 seeks life insurance from an insurer 104. The applicant 100 may be an individual seeking life insurance on their own or as a member of a group. Employees of an employer are a typical group of applicants. The employer in this case will typically negotiate a group insurance contract for the employees. The description will generally refer to the applicant in their individual capacity, and it should be appreciated that some variations may be necessary to effectively provide life insurance to a group. The insurer 104 is any insurance policy issuing entity such as an inurance company.

The insurer 104 issues a hybrid life insurance policy 102 to the applicant 100, which hybrid life insurance policy 102, as described in more detail herein below, is a hybrid of decreasing term life insurance coverage and paid-up life insurance coverage. The applicant 100 will also be referred to as the insured 100. In accordance with the preferred embodiment, the life insurance policy 102 pays, in exchange for one or more premium payments 106, a predetermined or calculated sum as a death benefit 105, to a beneficiary 107 upon the death of the insured 100. In accordance with the preferred embodiment, the premiums 106 are paid by the insured 100 to the insurer 104 at periodic intervals and the amount of each premium payment 106 is fixed at a constant dollar amount. For example, the insured 100 may pay a fixed premium 106 of sixty dollars each month over the term certain of the life insurance policy 102.

In accordance with the preferred embodiment, the term of the hybrid life insurance policy 102 is fixed for a certain number of years, i.e. it has a “term certain.” Typically, the term certain of the hybrid life insurance policy 102 is set to end on the date when the insured 100 reaches a specified age. The premiums 106 are paid periodically from the time the hybrid life insurance policy 102 is issued until the tern certain is reached or until the death of the insured 100, whichever occurs first. In accordance with the preferred embodiment, the term certain of the hybrid life insurance policy 102 is at least fifteen years. Typically the term certain of the hybrid life insurance policy 102 is reached when the insured 100 turns sixty-five years of age. However, it should be understood that any term certain is applicable. In one embodiment, the term certain is set to end at the later of the date when the insred 100 turns age sixty-five or fifteen years of premium payments from the date of issue.

The predetermined sum paid to the beneficiary 107 upon the death of the insured 100 is the face value of the hybrid life insurance policy 102. For example, a hybrid life insuance policy 102 with a face value of $30,000 would pay a death benefit of $30,000 to the beneficiary 107 upon the death of the insured 100, assuming that all of the required premium payments have been made. The hybrid life insurance policy 102 is structured so that a death benefit 105 in the amount of the face value is paid to the beneficiary 107 upon the death of the insured 100, whether the death occurs during the term certain of the hybrid life insurance policy 102 or after the term certain has ended, i.e., the insured 100 will have a paid-up life insurance policy 110 with no cash surrender value and a face value equal to the face value of the hybrid life insurance policy 102 at the end of the term certain.

The insured is required under the policy to make a specified number of premium payments before the term certain is reached. Premiums will typically be paid on a monthly basis, although annual, quarterly or any other period may be used. If the insured fails to make a premium payment, the term coverage of the hybrid life insurance policy may be canceled. However, a death benefit may still be paid to the beneficiary 107, despite the fact that the insured 100 paid less than all of the premiums 106 due on the life insurance policy 102. The death benefit 105, in the case where the term coverage has been canceled, will be equal to the current value of the paid-up life insurance policy 110 purchased by the premiums 106 actually paid.

The hybrid life insurance policy 102, in accordance with the preferred embodiment, includes decreasing term life insurance coverage 108 and paid-up life insurance coverage 110 with no cash surrender value. When the hybrid life insurance policy 102 is issued, the face-value of the hybrid life insurance policy, the term certain of the hybrid life insurance policy and the periodic premium amount 106 are set. If the premiums 106 were paid until the term certain ended or until the death of the insured 100, should the death occur before the end of the term certain, death of the insured 100 makes the insurer 104 liable for payment of the face value of the hybrid life insurance policy 102 to the beneficiary 107.

While the description will refer to the payment of the premium by the insured 100, it should be understood that another party may be responsible for the payment of premium. For example, an employer may bear responsibility for an employee's premiums. The fact that someone other than the insured is responsible for or pays the premiums does not affect the identification of the insured. The insured is the individual whose death is the trigger event for payment of the death benefit under the hybrid insurance policy, regardless of who pays the premiums.

One embodiment of the invention may be used to illustrate the hybrid life insurance policy 102. As noted herein above, hybrid life insurance policy 102 requires the insured 100 to pay the insurer 104 a plurality of periodic premium payments. Internally, the imsurance company may divide each premium into two parts. One portion of the premium is used as payment for decreasing term insurance coverage 108, where the term certain of the decreasing term coverage 108 is set as the term certain of the hybrid life insurance policy 102.

The remaining portion of the premium is used to purchase an unit of a paid-up coverage 110 withno cash surrender value. As each unit of the paid up coverage 110 is purchased, the face value of the paid up coverage 110 increases. For example, the term certain of a policy may require 480 monthly premium payments. The paid up coverage 110 portion of each monthly premium payment would be used to buy an incrementally smaller unit of paid up coverage 110. In accordance with an embodiment, the paid-up portion of each monthly premium is accumulated and used annually to pay for a unit of paid up coverage 110. If the insured dies during the course of the year, the premium payments actually made before the decease is used to pay for a partial-year unit of paid up coverage 110. In accordance with the preferred embodiment, the units of paid up coverage 110 are purchased on a monthly basis.

The face value at any given moment during the term certain of the decreasing term life insurance coverage 108 purchased is substantially equal to the difference between the face value of the paid-up coverage 110 at the time and the face value of the hybrid life insurance policy 102, such that if the insured 100 dies during the term certain, the face value of the term coverage and the present value of the paid-up coverage 110 combine to equal the face value of the hybrid life insurance policy 102. In this manner, after the hybrid life insurance policy 102 is issued and so long as premium payments are made in due course, the beneficiary receives a payment equal to the face value of the hybrid life insurance policy 102 when the insured 100 dies. Assuming that all premium payments were made, if the insured 100 were to die early in the term certain of the hybrid life insurance policy 102, the decreasing term coverage 108 would provide most of the face value. If the insured 100 dies after the term certain of the hybrid life insurance policy 102, assuming that all premium payments were made, the paid up coverage 110 provides all of the face value.

The portion of the premium used as payment on the decreasing term coverage 108 remains the same for the duration of the term certain. The remaining portion is used to pay for a unit of paid up coverage 110. The paid-up portion also remains the same for the duration of the term certain.

A unit of paid up coverage 110 is purchased with the second portion of the premium. After the first unit has been purchased, the insured's death benefit is vested, such that the deathofthe insured 100, whenever it occurs, will make the insurer 104 liable for payment of the present face value of the paid up coverage 110 to the beneficiary 107, where the present face value is calculated from the premiums paid.

If only some of the premium payments have been made, the units of paid up coverage 110 purchased with the premiums paid still provide a death benefit. Because there is no cash surrender value in the life insurance policy, the cost of the paid up coverage 110 in accordance with the preferred embodiment, is significantly less than it would be for other permanent life insurance plans like whole life insurance.

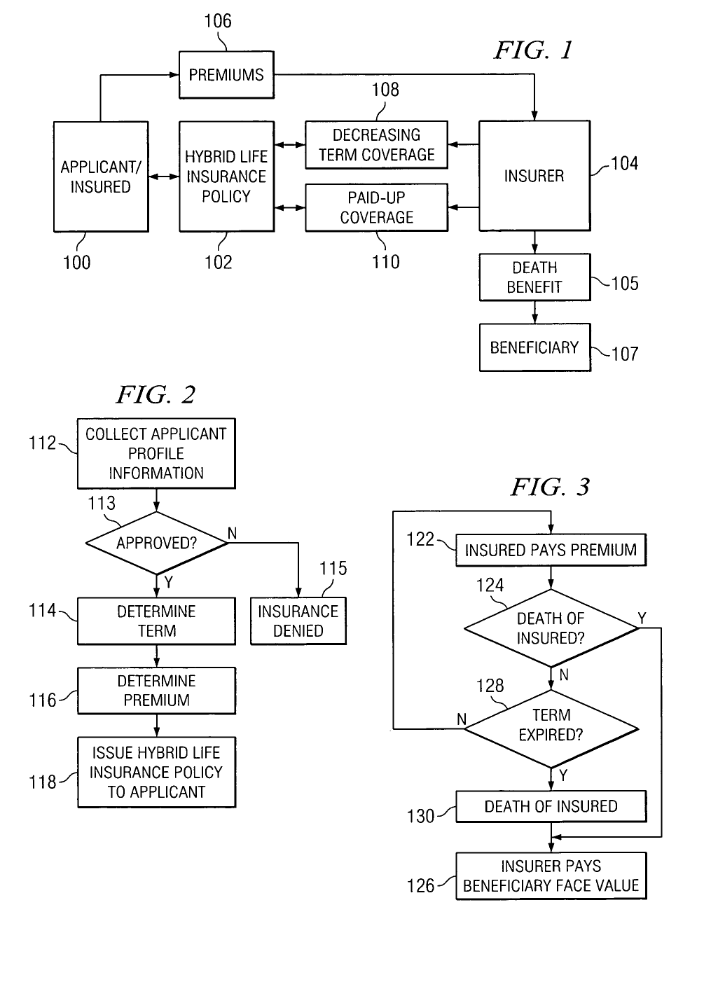

With reference to FIG. 2, a flowchart of the process for issuing a hybrid life insurance policy 102 in accordance with the preferred embodiment is shown. The process begins at function block 112. The insurer 104 collects profile information regarding the applicant. In the case of an individual applicant, typical information may include the age, health and other aspects of an individual's profile. In the case of a group, information regarding the size of the group, percentage participation, the type of occupation or other information relevant to the inurability of the group may be required. The process continues to decision block 113 to determine if the applicant will be insured. If the applicant has been turned down, the process follows the NO path to function block 115 to end the process. If the applicant is approved, the process follows the YES path to function block 114 where the desired face value of the hybrid life insurance policy 102 is selected. Typically the face value of the hybrid life insurance policy 102 may be $30,000.00, $50,000.00 or $100,000.00. In principle, any value may be chosen as the face value. Proceeding to function block 116, the term certain of the hybrid life insurance policy 102 is determined.

Proceeding to function block 118, the insurer 104 uses the applicant profile information, the face value and the term certain of the desired hybrid life insurance policy 102 to determine the premium 106. In accordance with the preferred embodiment, the premium is set at a fixed dollar level such that each payment during the term certain of the hybrid life insurance policy 102 is the same. It will be apparent to those having skill in the art that other premium structures could be used to collect the necessary funds to provide the insurance. The process continues at function block 120 where the hybrid life insurance policy 102 is issued to the insured 100.

With reference to FIG. 3, a flowchart of the insurance process in accordance with one embodiment is shown. The process begins at function block 122 as the insured 100 pays the premium 122 to insurer 104. Proceeding to decision block 124, if the insured 100 dies before the next premium payment, the process follows the YES path to function block 126 and the insurer 104 pays the beneficiary the face value of the hybrid life insurance policy 102. Otherwise the process follows the NO path to decision block 128 to determine if the term certain of the hybrid life insurance policy 102 has expired. If the term certain has not expired then another premium is due and the process follows the NO path to function block 122 for the payment of the premium. If the term certain has expired, then no further premiums are due and the process follows the YES path to function block 130. When the insured 100 dies, the process continues at function block 126. The insurer 104 pays the beneficiary the face value of the hybrid life insurance policy 102.

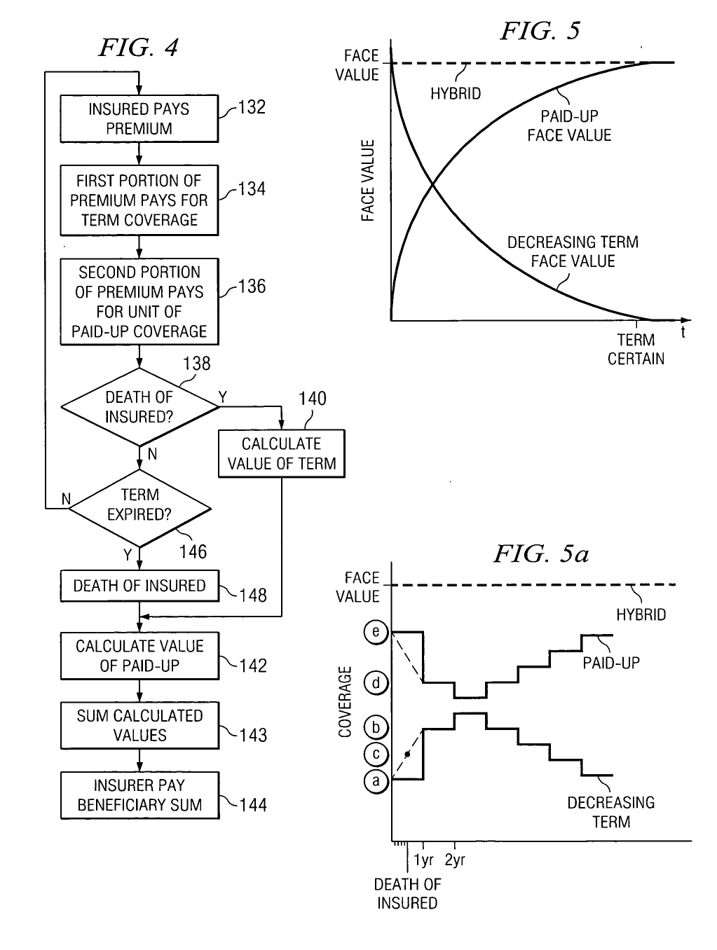

With reference to FIG. 4, a flowchart of the insurance process in accordance with another embodiment is shown. In the present embodiment, the insurer 104 provides coverages to issue the hybrid life insurance policy. The process begins at function block 132 as the insured 100 pays a periodic premium 122 to insurer 104. Proceeding to function block 134, the insurer 104 uses one portion of the premium payment to pay for the decreasing term coverage 108. At function block 136, the insurer 104 uses the remaining portion of the premium payment to pay for a unit of paid up coverage 110 on the insured 100. The decreasing term coverage 108 and the paid up coverage 110 are set up such that, after the policy is issued and so long as the premiums are paid in due course, the present value of the decreasing term coverage 108 and the present value of the paid up coverage 110, when summed, substantially equal the face value of the life insurance policy as defined at function block 114. As the face value of the paid up coverage 110 increases with each unit purchased, the present value of the decreasing term coverage 108 decreases at approximately the same rate.

Proceeding to decision block 138, if the insured 100 dies before the next premium payment the process follows the YES path to function block 140 and the insurer 104 determines the present value of the decreasing term coverage 108 at the time of the decease. Proceeding to function block 142, the insurer 104 determines the value of the paid-up coverage 110 at the time of the decease. Proceeding to function block 143, the insurer adds the value of the term coverage to the value of the paid up coverage 110. Proceeding to function block 144, the insurer 104 pays the beneficiary 107 the calculated sum. If all the premiums have been paid, the calculated sum will be substantially equal to the face value of the hybrid life insurance policy 102.

Otherwise the process follows the NO path to decision block 146 to determine if the term certain of the hybrid life insurance policy 102 has expired. If the term certain has not expired then another premium is due and the process follows the NO path to function block 132 for the payment of the premium. If the term certain has expired, then no further premiums are due and the process follows the YES path to function block 148. When the insured 100 dies, the process continues at function block 142. The insurer 104 calculates the value of the paid-up coverage 110. Because the term certain has expired, assuming that all premium payments were made, the value of the paid-up coverage 110 is substantially equal to the face value of the hybrid life insurance policy 102. Proceeding to function block 144, the insurer 104 pays the beneficiary the calculated value of the hybrid life insurance policy 102.

With reference to FIG. 5, a graph of the relationship between the payoff values of the decreasing term coverage 108 and the paid-up coverage 110 portions of the hybrid life insurance policy 102 is shown. In this graph, the x-axis represents the time between the issue of the hybrid life insurance policy 102 until after the end of the term certain of the hybrid life insurance policy 102. The y-axis represents the face value of the hybrid life insurance policy 102 and the component life insurance coverage. Because there is no cash surrender value, the hybrid life insurance policy 102 and the component coverages have no cash value until the decease of the insured 100.

The face value of the hybrid life insurance policy 102 is constant, as represented by the horizontal line at the face value amount. Whenever the decease of the insured 100 occurs, the hybrid life insurance policy 102 pays an amount equal to the face value to the beneficiary. The decreasing term life insurance component is represented by the curve descending from an amount just below the hybrid insurance policy face value at the time the hybrid life insurance policy 102 is issued to a zero value when the term certain has expired. The paid up coverage 110 is represented by curve ascending from an amount just above zero at the time the hybrid life insurance policy 102 is issued to equal the Face Value amount when the term certain has expired and subsequently.

When the hybrid life insurance policy 102 is initially issued, only a single unit of paid-up life insurance is purchased. The decreasing term coverage 108 purchased provides the bulk of the payment if the decease of the insured 100 occurs in the early years of the term certain. Once the term certain is expired, the decreasing term coverage 108 expires and the face value of the paid-up coverage 110 provides the entire face value of the hybrid life insurance policy 102.

With reference to FIG. 5a, a graph detailing the change in coverage during the term certain of the hybrid life insurance. Although typically a hybrid life insurance policy will require monthly payment of premiums, the paid up coverage 110 may be provided in single-premium annual paid-up life units. After twelve premiums have been collected, the insurer converts the payment into a single-premium paid-up life unit. The coverage provided by the paid up coverage 110 steps from level designated a to the level designated b. The decreasing term insurance is designed to decrease in accordance with the value of the paid up coverage 110, such that when the paid up coverage 110 increases from a to b, the decreasing term coverage 108 decreases by the same amount from level e to level d.

Because the premiums are typically paid on a monthly basis and the single-premium paid-up units are purchased annually, If the insured dies during the term certain of the hybrid life insurance policy, it is possible that not all premium payments have been used to pay for paid-up life coverage 110. In this case, the premiums actually paid will be used to purchase the appropriate fractional unit of paid-up life. For example, if the deceased were to die six months alfter the policy had been issued, designated doi on the graph, and all the premiums were paid, the insured would have made six months of premium payments that have not yet been applied to a unit of paid-up life. In this case the insurer would calculate the appropriate insrance for the premiums paid, designated c. The decreasing term coverage 108 would decrease accordingly.

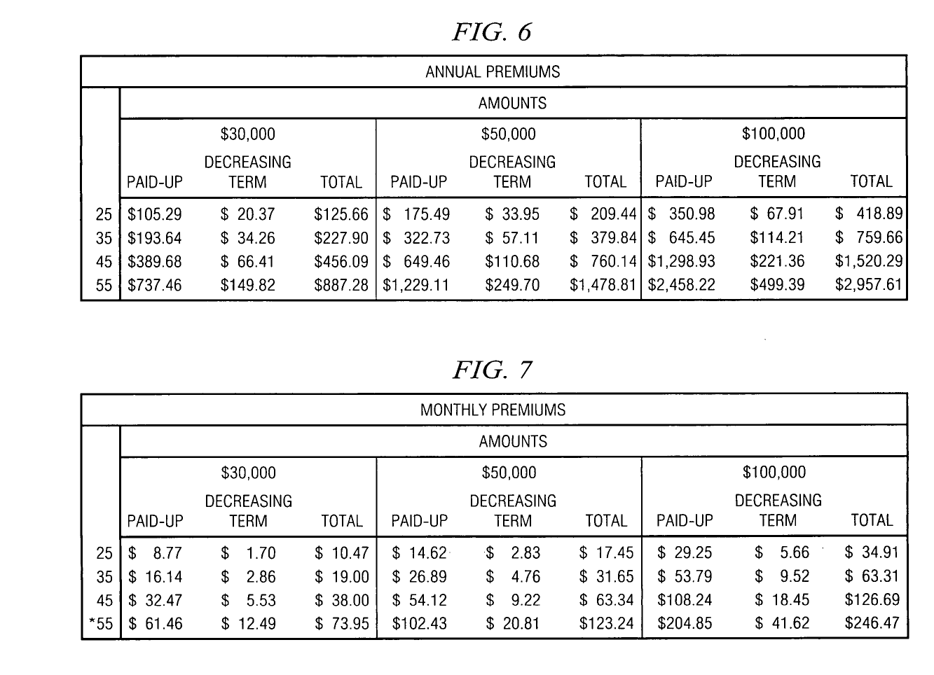

With reference to FIG. 6, a comparative chart of the annual premiums for various face amounts and age levels of insured are shown. For example, a 25-year-old purchasing a $30,000.00 hybrid life insurance policy 102 will pay a total annual premium of $125.66. Of the $125.66, $105.29 would be used to purchase a unit of paid up coverage 110, while the remaining $20.37 would be used to make payment on the decreasing term coverage 108. The increase in cost for a policy for each age occurs in part because of the increasing cost of the decreasing term coverage 108 for an older individual and the decreased time available to purchase the desired amount of paid up coverage 110.

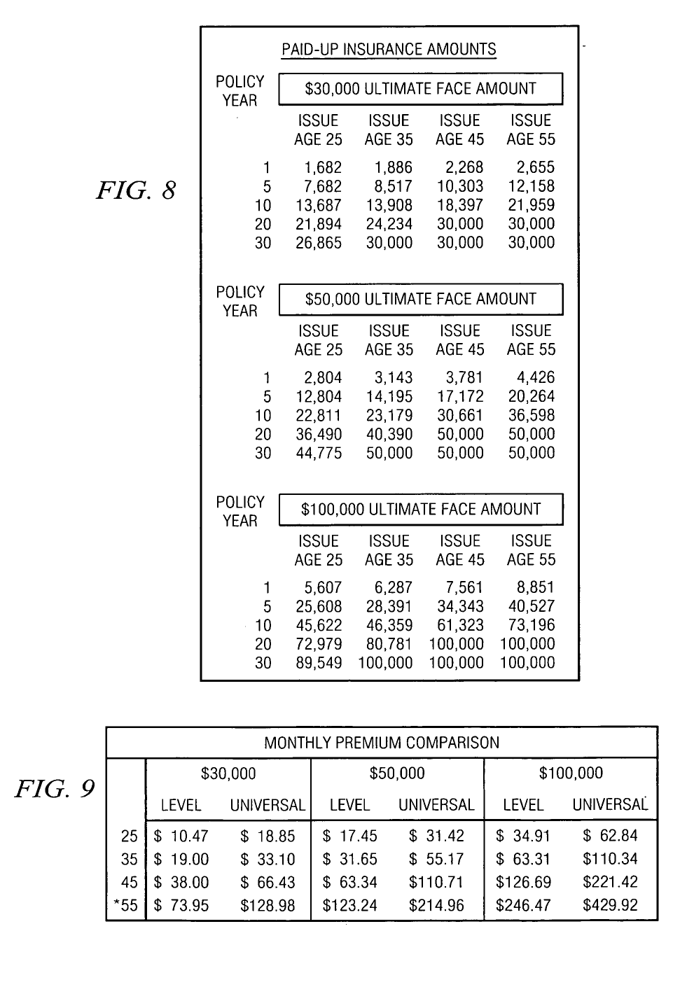

With reference to FIG. 7, a comparative chart of the monthly premiums for various face amounts and age levels of insured are shown. With reference to FIG. 8, a comparative chart of the accumulation of value in typical paid up coverage 110. With reference to FIG. 9, a comparative chart of the typical monthly premiums for a hybrid life insurance policy 102 in accordance with the invention and a Universal Life policy with the same face amount.

It will be appreciated by those skilled in the art having the benefit of this disclosure that this provides an advantageous method of providing life insurance. It should be understood that the drawings and detailed descirption herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method for providing life insurance, comprising:
issuing a life insurance policy to an insured with a face amount payable to a beneficiary and a term certain;
collecting premiums from the insured until either the term certain expires or the death of the insured, whichever comes first; and
paying the face amount to the beneficiary upon the death of the insured, wherein said life insurance policy has no cash surrender value.

2. The method of claim 1, wherein said life insurance policy comprises more than one component life insurance coverages.

3. The method of claim 2, wherein said life insurance policy comprises a decreasing term coverage component.

4. The method of claim 2, wherein said life insurance policy comprises a paid-up life coverage component.

5. The method of claim 2 wherein said component life insurance coverages pay benefits upon the death of the insured.

6. The method of claim 5 wherein said component life insurance coverages comprises a first life insurance coverage and a second life insurance coverage, such that the first life insunce coverage pays a first benefit upon the death of the insured and the second life insurance coverage pays a second benefit upon the death of the insured.

7. The method of claim 6, wherein the sum of the first benefit and the second benefit are substantially equal to the face value of the life insurance policy.

8. The method of claim 1, wherein said face value is paid to the beneficiary if the death of the insured occurs after the term certain has expired.

9. A hybrid life insurance policy issued to an insured by an insurer for a term certain with a face value value, wherein the hybrid life insurance policy is provided in accordance with a method of providing life insurance comprising:
issuing a hybrid life insurance policy to an insured with a face amount payable to a beneficiary and a term certain;
collecting premiums from the insured until the earlier of the term certain expiring or the death of the insured; and
paying the face amount to the beneficiary upon the death of the insured, wherein said hybrid life insurance policy has no cash surrender value.

10. The policy of claim 9, wherein said hybrid life insurance policy comprises more than one component life insurance coverages.

11. The policy of claim 10, wherein said hybrid life insurance policy comprises a decreasing term coverage policy component.

12. The policy of claim 10, wherein said hybrid life insurance policy comprises a paid-up coverage component.

13. The policy of claim 10 wherein said component life insurance coverages pay benefits upon the death of the insured.

14. The policy of claim 13 wherein said component life insurance coverages comprise a first life insurance coverage and a second life insurance coverage, such that the first life insurance coverage pays a first benefit upon the death of the insured and the second life insurance coverage pays a second benefit upon the death of the insured.

15. The policy of claim 14, wherein the sum of the first benefit and the second benefit are substantially equal to the face value of the life insurance policy.

16. The policy of claim 9, wherein said face value is paid to the beneficiary if the death of the insured occurs after the term certain has expired.

17. A method of providing life insurance to a group comprising:
negotiating a hybrid life insurance policy for a group with a face amount payable to a beneficiary and a term certain, wherein said hybrid life insurance policy has no cash surrender value; and
paying premiums on the hybrid life insurance policy; wherein the beneficiary is paid the face amount upon the death of the insured.
